(19) United States
(12) Patent Application Publication
(10) Pub. No.: US 2025/0209380 A1
(43) Pub. Date: Jun. 26, 2025

(54) METHOD TO DESIGN A METAL ORGANIC FRAMEWORK TO A TARGET MATERIAL

(71) Applicant: Schlumberger Technology Corporation, Sugar Land, TX (US)

(72) Inventor: Bruno Lecerf, Houston, TX (US)

(21) Appl. No.: 18/990,385

(22) Filed: Dec. 20, 2024

Related U.S. Application Data
(60) Provisional application No. 63/613,250, filed on Dec. 21, 2023.

(51) Int. Cl. G06N 20/00; B01D 53/02; B01D 53/30; B01D 53/34; B01D 53/62; B01D 53/81

(52) U.S. Cl. CPC G06N 20/00; B01D 53/02; B01D 53/30; B01D 53/346; B01D 53/62; B01D 53/81; B01D 2253/204; B01D 2257/504

(57) ABSTRACT

Embodiments presented provide for a workflow to identify a proposed metal-organic framework (MOF) to directly replace a sorbent material within a carbon dioxide capture system. The workflow disclosed and described below identifies target sorbent features associated with a sorbent material based on target sorbent properties. A subset of MOFs is selected from a MOF library based on reaction parameters of the target sorbent, and a machine learning algorithm is used to correlate MOF structures of the MOF training subset with the identified target sorbent features. A proposed MOF structure is identified as the most similar to the target sorbent.

### CROSS-REFERENCE TO RELATED APPLICATIONS

The present disclosure claims priority from U.S. Provisional Application No. 63/613,250, filed Dec. 21, 2023, entitled “Method to Design a Metal Organic Framework to a Target Material”, which is herein incorporated by reference in its entirety.

### FIELD OF THE DISCLOSURE

Aspects of the disclosure relate to a method for selecting and manufacturing a material for carbon capture. More specifically, aspects of the disclosure provide for identifying, testing, and implementing a sorbent material for carbon capture having target properties.

### BACKGROUND

The level of CO₂ in Earth's atmosphere is rapidly rising and is projected to double today's levels to reach 1000 ppm by 2100. These projections are primarily driven by anthropogenic sources. Carbon capture from anthropogenic sources and carbon removal from atmosphere, which can capture and sequester at gigaton scale by 2050, is becoming a desired technology to stop and reverse the impact of climate change.

In the capture process, CO₂ molecules must be separated from other gases that are present in the gas stream coming out of a power plant, an industrial facility, or a direct air capture (DAC) facility. Several well-established separation technologies exist to remove CO₂ from various emission sources, with solvent-based absorption technology being the most mature and deployed at industrial scale. However, the capture processes operating with aqueous amine (e.g., monoethanolamine) solvents often involve high energy costs associated with solvent regeneration. CO₂ separation techniques using solid sorbents, membranes, and cryogenics have currently been developed and tested in lab scale and pilot scale. Extensive research and development activities have been ongoing for the last two to three decades to increase the technical maturity of these nascent technologies and to reduce the cost of capture at industrial scale. Despite these efforts, there is a strong demand for new material development to improve the CO₂ capture capacity, selectivity over other gases, and to reduce the regeneration energy need.

Unlike the typical solvent technology, the usage of solid sorbents can reduce toxic gas emissions from solvents, alleviate the equipment corrosions issues, and potentially lower the operation energy consumption. While the technological progress has been promising, many technology obstacles continue to remain. The development of sorbents applicable to various physical conditions and flue gas mixtures is quite challenging, partly due to strong composition variations and partly due to different pressure and temperature conditions in the feed gas.

Sorbents have been developed for some applications having particular flue gas mixtures and operating parameters. The selection of one sorbent at an early stage in development of a capture facility may have significant effects on the sizing and arrangement of accompanying systems such as heat exchangers, vessels, flow control equipment, and conduit routing. Changing the sorbent during or after development may be costly or impractical due to changes in the accompanying systems.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are; therefore, not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a workflow is disclosed to identify a proposed metal-organic framework (MOF) to directly replace a sorbent material within a carbon dioxide capture system. The workflow disclosed and described below identifies target sorbent features associated with a sorbent material based on target sorbent properties. A subset of MOFs is selected from a MOF library based on reaction parameters of the target sorbent, and a machine learning algorithm is used to correlate MOF structures of the MOF training subset with the identified target sorbent features. A proposed MOF structure is identified as the most similar to the target sorbent.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a flowchart illustrating a method of designing a MOF that matches the performance of a sorbent;

FIG. 2 is a flowchart illustrating a method of designing a MOF that matches the performance of a sorbent.

### DETAILED DESCRIPTION

In the following, reference is made to embodiments of the disclosure. It should be understood; however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

The systems and workflows presented herein utilize Artificial Intelligence (AI) to design a Metal-Organic Framework (MOF) that matches the performance of a fully characterized sorbent. Some known sorbent materials may be fully characterized such that the reaction parameters, chemical composition, chemical structure, and performance metrics for a wide variety of gas mixtures may be known. Despite the full characterization of a sorbent being known, the sorbent material itself may be unavailable, such as for cost, access, or know-how reasons. Accordingly, it may be desirable to identify one or more alternative materials that may be used in place of the known sorbent. The systems and workflows presented below seek to characterize a target based on an existing sorbent. The existing sorbent may include zeolites, or activated carbons (also called porous carbons), alkanized alumina, known for their high surface areas and porosity. These materials physically adsorb CO₂ molecules, primarily through van der Waals forces. Sorbents may also include chemical sorbents, such as amine-functionalized solids, react chemically with carbon dioxide to form stable compounds, facilitating efficient capture. The existing sorbent may or may not be a MOF. The systems and workflows discussed below can be used to retrofit a MOF into an existing process/equipment without modifying any of the process design. This would enable to use the same process as for the target sorbent to adsorb CO₂ using the newly-identified sorbent.

In some embodiments, the proposed MOF may be used to match some target sorbent properties of a certain sorbent, and to improve other target sorbent properties. For example, a first sorbent may be utilized with a carbon capture system having first absorption conditions (T₁, P₁, CO₂ concentration C₁) and first regeneration conditions (T₂, P₂, C₂). The first sorbent may have a first density D₁, a first sensitivity S₁ to contaminants, and a first cost E₁. The first sorbent may facilitate a first capture rate R₁ and have a first lifespan L₁ prior to replacement. The systems and workflows discussed herein may identify a proposed MOF capable of direct replacement of the first sorbent because of similar MOF properties for the first absorption conditions, the first regeneration conditions, and the first density. In some embodiments, the proposed MOF may exhibit improved MOF properties, such as a greater capture rate R₂, longer lifespan L₂, lower cost E₂, or lower sensitivity S₂ to contaminants. A MOF may be identified as described herein and used as a direct replacement of an existing sorbent with no modification or minimal modification to the capture system. Using a MOF as a direct replacement for the sorbent may enable some improvements to the system (e.g., improved energy efficiency, increase capture rate, reduced servicing costs, reduced operating costs) without significant changes to the capture system that involve capital expenditures or system downtime. In some embodiments, the proposed MOF may exhibit similar MOF properties for a different range of absorption or regeneration conditions, thereby enabling later changes to the capture system at the operator's convenience.

Metal-Organic Frameworks (MOFs) are developed and explored with various computational techniques for specific uses. Molecular modeling and simulation, including molecular dynamics and Monte Carlo simulations, are employed to understand how MOFs interact with various molecules. This helps in predicting adsorption capacities and selectivity. Quantum chemical calculations, such as Density Functional Theory, provide insights into the electronic structure of MOFs, crucial for designing frameworks for catalysis or other electronic applications.

Machine learning and artificial intelligence are increasingly utilized to predict MOF properties from large datasets, identifying promising structures for synthesis. High-throughput screening enables the rapid evaluation of vast libraries of hypothetical MOFs to determine those with the most desirable properties for specific applications. These computational strategies aid in exploring the vast design space of MOFs, leading to the rational design of materials with customized properties for various applications like gas storage, separation, catalysis, or drug delivery.

The use of Artificial Intelligence (AI), particularly machine learning (ML), in predicting the properties of Metal-Organic Frameworks (MOFs) represents a cutting-edge intersection of materials science and computational technology. AI offers several significant advantages in this field:

Predictive Modeling: AI algorithms can predict a wide range of MOF properties, such as gas adsorption capacities, selectivity, stability, and even potential applications in catalysis or drug delivery. By training on existing datasets of MOF structures and their properties, these models can forecast how new, untested MOFs might behave.

Pattern Recognition and Data Analysis: Machine learning is excellent at identifying complex patterns in large datasets. In the context of MOFs, ML can analyze structural features and correlate them with specific functional properties, helping scientists understand key design principles.

Accelerating Discovery: Traditional methods of synthesizing and testing new materials can be time-consuming and expensive. AI models can rapidly screen virtual libraries of MOF structures to identify those most likely to exhibit desired properties, significantly speeding up the discovery process.

Optimization of MOF Design: AI can assist in optimizing MOF structures for specific applications. For example, by tweaking parameters like pore size, metal nodes, and organic linkers, AI can help design MOFs with enhanced performance for gas storage or separation.

Integration with High-throughput Experimentation: AI tools can work in tandem with high-throughput experimental techniques, where large numbers of MOF samples are synthesized and tested. AI can quickly analyze this data to identify promising candidates and suggest new experiments.

Customization for Specific Applications: For specialized applications like drug delivery, AI can help tailor MOFs to interact optimally with specific drug molecules, enhancing efficacy and targeting.

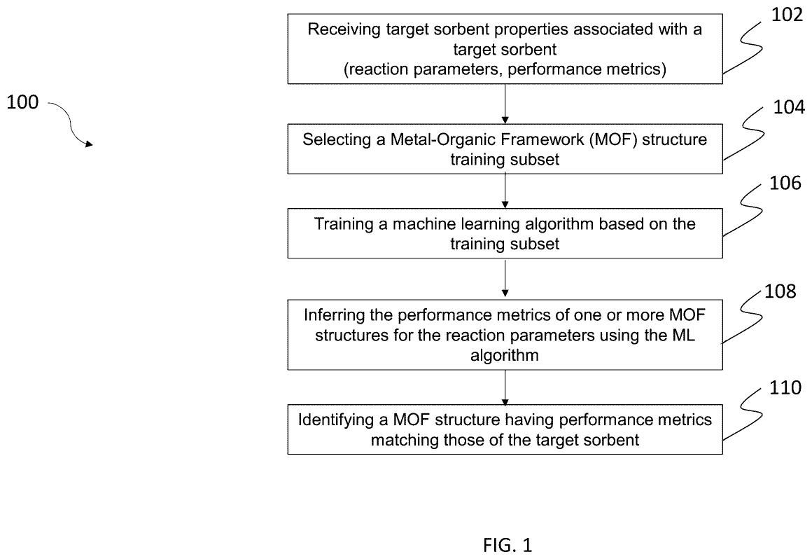

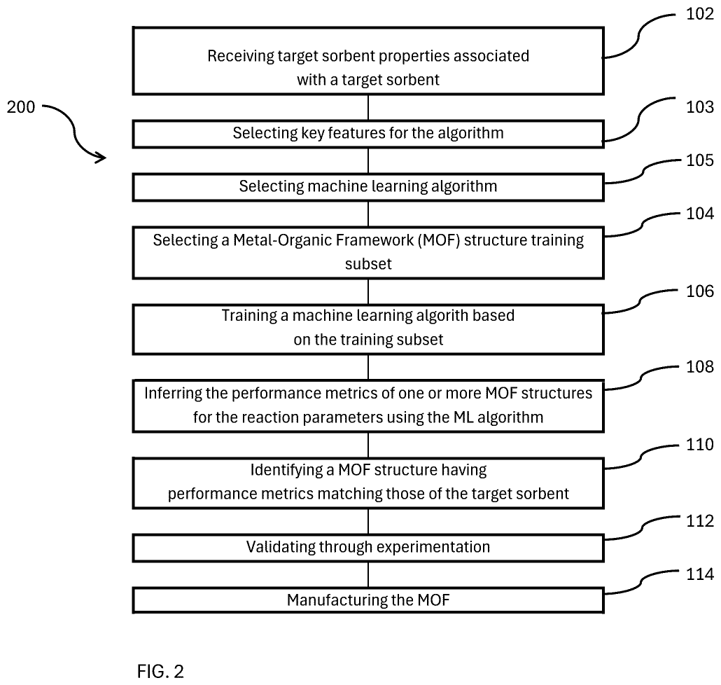

To realize the goal of designing a MOF that matches the performance of a fully characterized sorbent, the following steps should be undertaken (shown in relationship to FIG. 1 and FIG. 2) showing a flowchart of a method 100 according to one or more embodiments of the disclosure):
1. Data Collection and Preparation (stage 102): The method includes receiving sorbent properties associated with a target sorbent. Comprehensive data must be gathered on the existing sorbent. The gathered data include the reaction parameters (ie process parameters used with the existing target sorbent), and performance metrics. Reaction parameters may vary by the desired fluid constituent to absorb and the fluid mixture itself. The reaction parameters may include, but are not limited to, absorption flow composition, absorption temperature, regeneration temperature, regeneration pressure, absorption flowrate, regeneration flowrate, regeneration flow composition, and contaminants present. Performance metrics are target properties of the existing sorbent that the AI-generated MOF is expected to match. Performance metrics may include absorption rate. It may also include one or more of density, lifespan, sensitivity to one or more contaminants, working capacity, heat of reaction, manufacturing cost, and/or any other property of interest for the identified reaction parameters.
2. Optional Feature Selection: Key features contributing to the sorbent's performance should be identified (stage 103). These might include pore size, pore volume, micropore volume, bulk density, surface area, functional groups, and stability factors, which are instrumental in guiding the AI model. Identifying the key features may help determining the features that should be taken into account in the machine learning model. This stage is however optional. In some embodiments, the selected features may be ranked and prioritized. For example, the working capacity, and durability may be selected as higher priority features than pore size and density, and cost may be selected as the lowest priority. In some embodiments, conditional ranges may be used to select key features. For example, a working temperature range may be selected to correspond to a desired working capacity such that MOFs with properties outside of the temperature range or with a lower working capacity therein may be ignored by the AI model. In some embodiments, prioritized features may be selected within an adjustable range of the target property. For example, it may be desired to identify MOFs having a prescribed functional group (e.g., priority feature 1) that are operable within an adsorption temperature range (e.g., conditional priority feature 2) and having a density within 10% of a target density range. (priority feature 3). In some embodiments, features may be prioritized to favor identification of MOFs matching a first set of priority features over a second set of priority features. Multiple combinations and assortments of key features may be selected and identified for provision to the AI model to identify and display MOFs for consideration with the target sorbent. The AI model may use the selected features to order the operation of the model. In some embodiments, the AI model uses the selected features to sort the display of identified MOFs.
3. Optional Machine Learning Model Selection: A suitable machine learning model should be chosen (stage 105). Options like neural networks, regression trees, or support vector machines are considered. In an alternative embodiment, several machine learning models may be run in parallel.
4. Training Dataset Selection: (stage 104) A training dataset comprising various MOFs with known properties is selected. In an embodiment, the dataset is specifically developed. To date, tens of thousands of MOFs have been experimentally synthesized. The training dataset may be selected through a tool, such as the Quantum MOF Database, which includes density functional theory (DFT) computed properties of approximately 20,000 MOFs and related MOF-like materials. The training dataset includes a set of the MOFs that have been fully characterized experimentally: the database includes properties (such as chemical composition, structure) and performance of such MOFs. In an embodiment, the dataset is an existing dataset. In an embodiment creating the database includes inferring performance metrics for the reaction parameters from performance metrics for other parameters. This may be done using a physical model, and/or a machine learning model.
5. Model Training and Validation (stage 106): The model is trained using a training dataset. In an embodiment, the model parameters are determined using a first subset of the MOFs in the training dataset, having known performance metrics and set of properties. It infers a relationship between the MOF properties and the MOF performance metrics (at the specific reaction parameters). The model may be guided by the user (ie the user provides features of interest to guide the model) or not (ie the model may determine the features of interest without any user input, such as with a neural network). The AI model is validated by testing on a second subset of data of the training dataset not used in training, containing other MOF structures having known performance metrics and set of properties. In an embodiment, the model training and validation may be performed using several training and/or validation datasets and/or in an iterative manner until a certain confidence level is reached. The confidence level may be user-defined.
6. Performance metrics inference (stage 108): The AI model is used to simulate MOF designs, inputting the desired performance characteristics based on the sorbent, allowing the model to suggest MOF structures likely to exhibit similar properties. This may be done for instance by identifying the most relevant MOF structures in existing MOF structure databases, for instance by computing a relevance score for the known MOF (for instance the sum of the differences between the value of the performance metric and the threshold, with a ponderation, or any other appropriate method). Optionally, this may include (randomly) generating variations of the said MOF structures using design rules, and inferring the performance metrics of the generated MOF structure for the specific reaction parameters.
7. Identification of the appropriate MOF (stage 110): The MOF for which the performance metrics have been computed are analyzed to check if they realistically match the sorbent's performance. Several iterations of model refinement may be necessary. For instance, taking the example above, a relevance score of each of the generated MOF structure may be computed and a second set of generated MOFs may be designed based on one or more MOFs having the best performance score than the starting MOF.
8. Experimental Validation: A promising MOF design is synthesized experimentally and its performance tested (stage 112). The results are compared with the existing sorbent to assess the match in functionality. In an embodiment, a MOF body having one or more MOF crystals of the identified composition is manufactured. Said MOF bodies may be linked by a bonding agent that also includes the MOF but in a partially non-crystallized phase.
9. Refinement Based on experimental results, the AI model and MOF design are further refined as necessary. For example, stages 102-110 may be repeated until a MOF structure having properties matching those of the target sorbent is identified, manufactured, and validated.
10. Manufacturing of the MOF. In an embodiment, the identified one or more MOFs having the target properties is used to manufacture a MOF body that includes several MOF crystals bound together, in particular by a MOF in a non-crystallized phase, potentially with additives, forming optionally a monolithic MOF. It represents an advanced form of MOF materials, distinct from its conventional powdered counterparts and designated as m-MOF in the following. Such m-MOFs are essentially solid, continuous structures, often exhibiting porous architecture, offering several advantages including reduced pressure drop relative to powdered counterparts, enhanced mechanical stability, improved scalability and/or handling. Such m-MOF may have a volume greater than a powdered MOF, for instance a volume higher than 0.1 mm³, optionally 1 cm³. In another embodiment, the method according to the disclosure is able to identify the performance of the MOF body as a sorbent. In an embodiment, the MOF body is manufactured to match the macroproperties of the target sorbent pellets, ie size, dimensions, aspect ratio. The MOF body may be molded in order to reach said macroproperties.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure. Accordingly, the scope of the present claims or any subsequent claims shall not be unduly limited by the description of the embodiments described herein.

What is claimed is:

1. A method, comprising:
receiving target sorbent properties associated with a target sorbent, the target sorbent properties comprising reaction parameters, and performance metrics;
selecting a Metal-Organic Framework (MOF) training subset from a MOF library;
utilizing a machine learning algorithm to correlate MOF structures of the MOF training subset with the identified target sorbent features, wherein each MOF structure is associated with respective MOF sorbent properties; and
identifying a proposed MOF structure from the MOF training subset with MOF sorbent properties most similar to the target sorbent properties of the target sorbent.

2. The method of claim 1, wherein the machine learning algorithm includes at least one of neural networks, regression trees, and support vector machines.

3. The method of claim 1, comprising:
validating the MOF sorbent properties of the proposed MOF structure through experimental synthesis; and
comparing the validated MOF sorbent properties to the target sorbent properties.

4. The method of claim 3, comprising replacing the target sorbent in a carbon capture system with a monolithic MOF having the proposed MOF structure.

5. The method of claim 1, including identifying target sorbent features associated with the target sorbent based on the target sorbent properties; and using the target sorbent features in the machine learning model.

6. The method of claim 1, wherein the performance metrics include one or more of absorption rate, density, lifespan, sensitivity to one or more contaminants, working capacity, heat of reaction, manufacturing cost, or a combination thereof.

7. The method of claim 1, wherein the reaction parameters include one or more of absorption flow composition, absorption temperature, regeneration temperature, regeneration pressure, absorption flowrate, regeneration flowrate, regeneration flow composition, and contaminants.

8. A method, comprising:
receiving target sorbent properties associated with a target sorbent, the target sorbent properties comprising at least reaction parameters, and performance metrics;
selecting a Metal-Organic Framework (MOF) structure training subset from a MOF library;
training a machine learning algorithm based on the training subset to correlate a set of properties of MOF structures and performance metrics for the reaction parameters of said MOFs,
inferring the performance metrics of one or more MOF structures for the reaction parameters using the machine learning algorithm based on the set of properties for the one or more MOF structures,
identifying a MOF structure having performance metrics at least as advantageous as the target sorbent based on the inferred performance metrics for each of the one or more MOF structures.

9. The method of claim 8, wherein the set of properties of the MOF structures at least include a chemical composition and a chemical structure.

10. The method of claim 8, comprising:
validating the MOF performance metrics of the proposed MOF structure through experimental synthesis; and
comparing the validated MOF performance metrics to the target performance metrics.

11. The method of claim 10, including synthetizing a MOF body including one or more MOF crystals having the proposed MOF structure bonded by a bonding agent, wherein the bonding agent optionally includes a non-crystallized MOF, preferably having the same composition as the MOF structure.

12. The method of claim 11, wherein the MOF body is synthesized to match one or more of the size, dimensions and aspect ratio of pellets of the target sorbent.

13. The method of claim 8, comprising replacing the target sorbent in a carbon capture system with a MOF body including one or more MOF crystals having the proposed MOF structure bonded by a bonding agent, wherein the bonding agent optionally includes a non-crystallized MOF, preferably having the same composition as the MOF structure.

14. The method of claim 8, including identifying target sorbent features associated with the target sorbent based on the target sorbent properties; and using the target sorbent features in the machine learning model.

15. The method of claim 8, wherein the performance metrics include one or more of absorption rate, density, lifespan, sensitivity to one or more contaminants, working capacity, heat of reaction, manufacturing cost, or a combination thereof.

16. The method of claim 8, wherein the reaction parameters include one or more of absorption flow composition, absorption temperature, regeneration temperature, regeneration pressure, absorption flowrate, regeneration flowrate, regeneration flow composition, and contaminants.

17. The method of claim 8, wherein identifying the MOF structure includes selecting a MOF structure in a MOF database.

18. The method of claim 8, including generating a new MOF structure using predetermined chemical design rules and inferring the performance metrics of the new MOF structure using the machine learning model.

19. The method of claim 18, including designing a first set of new MOF structure based on a first MOF structure, identifying a second MOF in the first set of new MOF structure based on performance metrics inference and designing a second set of new MOF structures based on the second MOF structure.

20. The method of claim 8, wherein identifying the MOF structure includes computing a performance score for each MOF structure, wherein the performance score is based on the inferred performance metrics and the performance metrics of the target sorbent, and selecting the one or MOF structure based on the performance score.
